(19) United States
(12) Patent Application Publication
(10) Pub. No.: US 2019/0122292 A1
(43) Pub. Date: Apr. 25, 2019

(54) SYSTEM AND METHOD FOR A HOLOGRAPHIC DISPLAY FOR LOW INVENTORY

(71) Applicant: Walmart Apollo, LLC, Bentonville, AR (US)

(72) Inventors: Andrew Riggins, Fayetteville, AR (US); Steven Lewis, Bentonville, AR (US); Matthew Biermann, Fayetteville, AR (US)

(73) Assignee: Walmart Apollo, LLC, Bentonville, AR (US)

(21) Appl. No.: 16/134,611

(22) Filed: Sep. 18, 2018

Related U.S. Application Data
(60) Provisional application No. 62/574,514, filed on Oct. 19, 2017.

(51) Int. Cl. G06Q 30/06; G06Q 10/08; G06F 3/042; G06F 3/0488; G03H 1/00

(52) U.S. Cl. CPC G06Q 30/0643; G06Q 30/0623; G06Q 10/087; G03H 2001/0061; G06F 3/04883; G03H 1/0005; G06F 3/0425

(57) ABSTRACT

Systems, methods, and computer-readable storage media for a store shelving system which can use a scale, a laser tracking system, or other mechanisms for determining how much product remains on the shelf. When the amount of product remaining on the shelf is below a threshold amount, or when the shelf inventory is exhausted, the store shelving system can deploy (1) a hologram of the product, such that customers or store associates in the aisle next to the shelf see the hologram of the product in the location where the product would be if it were available; (2) a user interface which can provide information about the product; or (3) both the hologram of the product and the user interface.

### BACKGROUND

### 1. Technical Field

The present disclosure relates to holographic displays for shelved items, and more specifically to displaying holograms of items with low to exhausted inventory in place of physical items, and using holographic or tangible user interfaces to receive user input.

### 2. Introduction

When looking for a particular product on a store shelf, the customer naturally walks down the aisle and looks for that product. However, when the shelf inventory for the product is exhausted, or the product is out of stock, or when the shelf inventory is low and only the items at the back of the shelf remain, the customer may be unable to easily identify where the desired product is supposed to be located. In that situation, the customer may continue looking for the product elsewhere, not realizing they have already passed by its shelf location. The customer may even think the store does not carry the product. In addition, because there are not any products easily visible from the aisle, store associates restocking items may mistakenly place products in the wrong locations. Moreover, when the shelf inventory is low or exhausted, the only option generally available to customers is to search out and ask a store associate if there may be additional inventory in the back storage room. However, in circumstances where there is no store associate available, a customer who wants to make a purchase may leave empty handed.

### SUMMARY

An exemplary multi-tiered gondola shelf configured as disclosed herein can include: a first shelf configured to hold a product; a second shelf, which is immediately above the first shelf and separated from the first shelf by a shelf height; a sensor configured to detect when an amount of the product on the first shelf is below a threshold amount; a motion capture device; and a projection device in communication with the sensor, wherein when the sensor detects that the amount of the product on the first shelf is below the threshold amount, the projection device displays: a hologram of the product; and a holographic user interface configured to display information about the product to a user; and wherein as the user interacts with the holographic user interface, the motion capture device: captures movements of the user; translates the movements of the user into a user command; and transmits the user command to the projection device, causing the holographic user interface to be modified based on the user command.

An exemplary shelving system configured as disclosed herein can include: a first shelf configured to hold a product; a second shelf, which is immediately above the first shelf and separated from the first shelf by a shelf height; a sensor configured to detect when an amount of the product on the first shelf is below a threshold amount; and a projection device in communication with the sensor, wherein when the sensor detects that the amount of the product on the first shelf is below the threshold amount, the projection device displays a holographic user interface configured to display information about the product to a user.

An exemplary method as disclosed herein can include: receiving, at a processor and from a sensor, a notification that a product stored on a first shelf is below a threshold inventory amount; causing a projection device mounted on a second shelf to project a hologram of the product such that the hologram of the product appears on the first shelf, the projection device being mounted to a second shelf directly above the first shelf; receiving, from a user interface, a command from a user regarding the product; and transmitting instructions to a mobile device associated with a store associate based on the command.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an example shelf configuration from a first perspective;

FIGS. 2A and 2B illustrate an example shelf configuration from a second perspective at two distinct times;

FIG. 3 illustrates an exemplary hologram device;

FIG. 4 illustrates an example method embodiment; and

FIG. 5 illustrates an example computer system.

### DETAILED DESCRIPTION

A store shelving system can use a mechanism to track how much shelf inventory for a product is remaining on a shelf. For example, the store shelving system can use a scale, a laser tracking system, or other mechanisms for determining how much product remains on the shelf. When the amount of product remaining on the shelf is below a threshold amount, or when the shelf inventory is exhausted, the store shelving system can deploy (1) a hologram of the product, such that customers or store associates in the aisle near to the shelf see the hologram of the product in the location where the product would be if it were available; (2) a user interface which can provide information about the product; or (3) both the hologram of the product and the user interface.

A hologram is a three-dimensional image formed by the interference of light beams from a laser, photographic projection, or other coherent light source. The hologram of the product can be created in any known manner. Non-limiting, exemplary types of holograms can include: reflection holograms, transmission holograms, hybrid (partially reflection and transmission) holograms.

The hologram of the product generated is, in a preferred configuration, presented in the same location where products would be stored on a store shelf if the product where stocked, with the optimal viewing angle of the hologram directly in-front of the shelf. However, in other configurations the hologram of the product can be turned at an angle so that customers approaching from a specific angle see the hologram of the product, then as the customers approach the product (and the view deteriorates) the customer can realize a hologram is being presented.

The user interface which can be presented to the customer can be, for example, a holographic user interface or a touch-screen interface. If, for example, the user interface is holographic, a sensor can be configured to record the motions of the customer interacting with the holographic user interface. This sensor can record metrics such as the relative positions of the customer's hands with respect to the user interface, movement of the customer's hands, and shapes of the customer's hands. Other detection mechanisms (such as facial detection, full-body sensors, etc.) could be used to capture the user interacting with the user interface.

The user interface can be used to communicate information about a product to the customer. For example, if the product associated with the user interface is a can of soup, the user interface can provide nutritional information, pricing information (price, coupon availability, discounts, etc.), and/or other product information. The user interface can also include information regarding inventory. If, for example, there are still some product items on the shelf which would not be immediately visible to the customer, the user interface can provide the remaining shelf inventory to the customer. Likewise, if there are additional product units within the store (for example, in a storage room, in an endstop display, or other section of the store), the user interface can inform the customer of those other units.

In some instances, the user interface can be configured to allow the customer to request that a store associate bring additional units from the storage room (or other location) to the shelf. In such configurations, the touch screen/movement sensor records the input and/or motions of the customer, translate the input to a request or command, then transmit that request to a store associate's mobile device (smartphone, tablet, MC40, etc.). The store associate's mobile device receives the request, the store associate could fulfill the request, and the customer can leave with the product they were shopping for, despite the product not having initially been stocked on the shelf.

In some configurations, a single projector or holographic device can be used for more than a single product. For example, if two distinct types of cereal are next to each other and both are below the threshold amount at which a hologram is generated, a single projector or holographic device can project holograms of both respective cereals. Depending on the size of the products and the spaces allocated for each product, the projector can leave a space between the respective holograms, or the respective holograms can be contiguous.

The disclosure now turns to the figures.

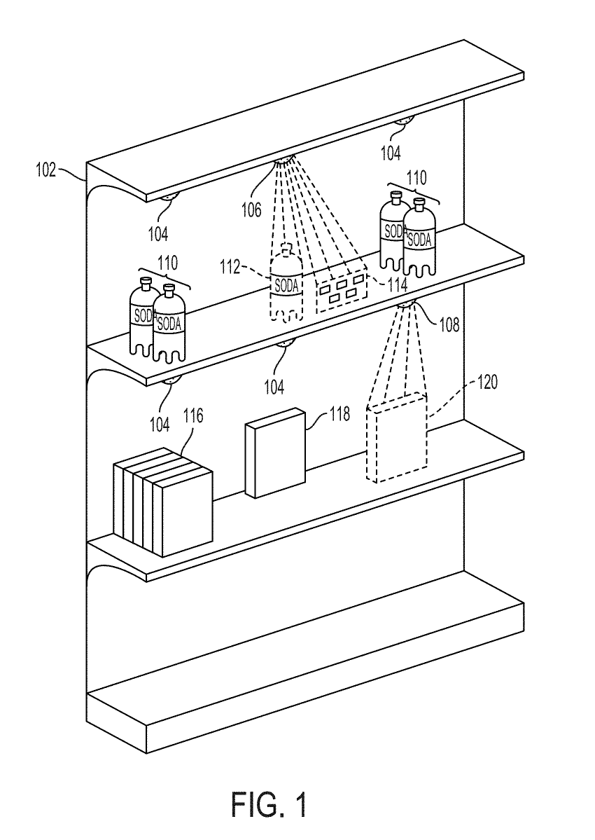

FIG. 1 illustrates an example shelf configuration from a first perspective. In this example, a gondola-style shelving system 102 has multiple shelves on which products 110, 116, 118 can be stored. Above the products, attached to the bottom side of the respective shelves, are sensors, projectors, and/or holographic devices 104, 106, 108 which can detect the amount of product remaining on the shelf and project a hologram when needed. The sensors illustrated can, for example, use lasers, RF feedback, or other mechanisms to determine how much stock is left of products on a shelf. In other, non-illustrated configurations, the inventory sensors can be built into the shelf and weigh the products (as a scale). In such configurations, the product-specific weight can be stored in a database, and using that product-specific weight with the weight from the scale/sensor a processor/server can calculate, in real-time, how many units of the product are currently on the shelf. Based on that calculation of the current shelf inventory, instructions to the projector or holographic display can initiate projection of the hologram.

In this example, there are two shelves with distinct products. On the top shelf there are bottles of soda 110, however the middle location on the shelf does not have any product available. Because of that, the projector 106 above the middle location is projecting a hologram of a soda bottle 112, and is also projecting a user interface 114 through which the user can look up information about the product, other locations (in or out of the store) which have inventory of the product, and/or request additional product be brought out from storage. On the bottom shelf, two product locations have product, one where the product 116 takes up most of the shelf space, and another where the product 118 takes up little shelf space but still does not trigger projection of a hologram. A third product location does not have any inventory remaining, resulting in the projector 108 displaying a hologram 120 of the missing product. In this case, no user interface is displayed.

The ability to display the user interface 114 can be based on factors such as the number of interactions users have had with the user display for a given product, the nature of the product, additional details available for display, additional inventory available (for example, the ability to request additional inventory might not be presented if there is no extra inventory available), and/or shelf space between products.

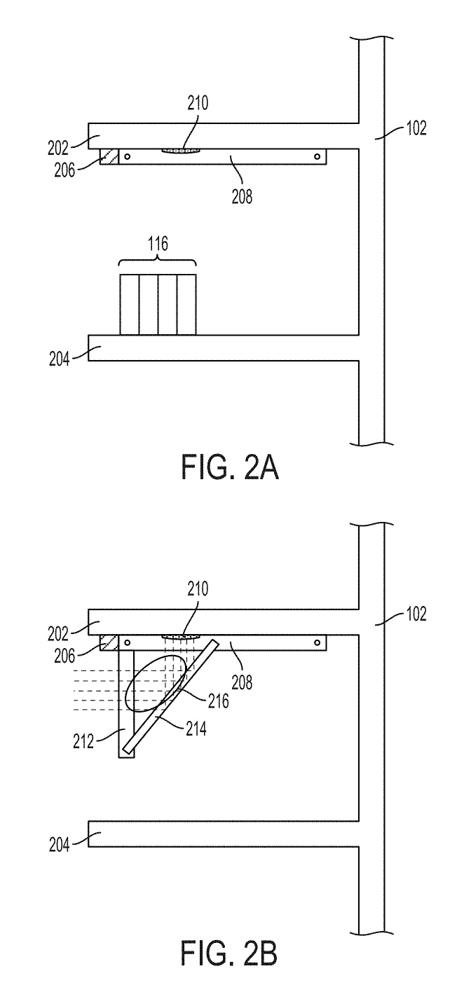

FIGS. 2A and 2B illustrate an example shelf configuration from a second perspective at two distinct times. In both systems, two shelves, a top shelf 202 and a bottom shelf 204 are attached to a back support system 102. These shelves 202, 204 can be adjustable, such as in a gondola shelf system. In these examples, attached to the bottom of the top shelf 202 are a sensor 206 for determining how much product 116 is remaining on the bottom shelf 204, a projection device 210, and a storage system 208 for a hologram reflection device. In FIG. 2A, the shelf 204 still has products 116 stored on it, so the hologram reflection device remains within the storage system 208.

In FIG. 2B, the products on the bottom shelf 204 are exhausted, and the hologram reflection device 214 is deployed from within the storage system 208. In this example, the storage system 208 uses motorized tracks to lower a reflective surface 214 and a transparent (or semi-transparent) touch screen 212. The projection device 210 then projects an image 216 which hits the reflective surface 214, reflects, and is projected through the touch screen 212.

As illustrated, there is a gap between the bottom of the reflective surface 214 and the bottom shelf 204. However, in many configurations the reflective surface 214, when deployed, reaches to the bottom shelf 204 such that the holographic projection of the exhausted product appears to be “on” the bottom shelf 204. In some configurations, the sensor 206 which detects the amount of remaining product can be integrated into the projection device 210, thereby reducing the number of distinct components required. In configurations which do not rely on a reflective holographic surface 214, the motorized track system of the storage system 208 can be removed and the projection device 210 can project the hologram without deploying a surface.

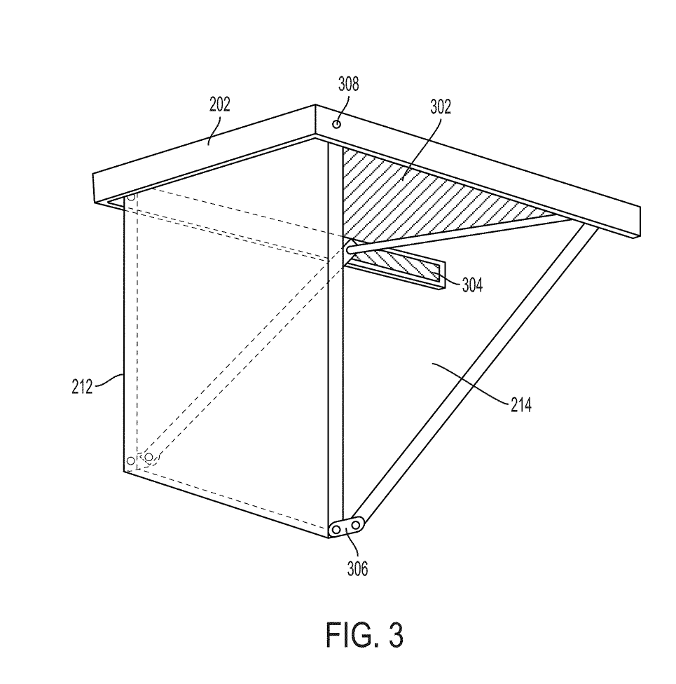

FIG. 3 illustrates an exemplary hologram device, such as the one deployed in FIG. 2B. In FIG. 3, the reflective surface 214 and the touch screen 212 are connected via a hinge 306. A screen/projector 302 is in the top of the storage area, and is covered/hidden/protected when the screen is not deployed. To deploy the reflective surface 214 and touch screen 212, a motorized track 304 moves the reflective screen forward, dropping both the touch screen 212 and reflective surface 214. When the product is restocked, the reflective surface 214 is moved, within the motorized track 304, backwards, such that the reflective surface 214 and the touch screen 212 move up into a storage configuration. When moving in and out, the touch screen 212 can pivot using a front hinge 308 near the aisle portion of the shelf.

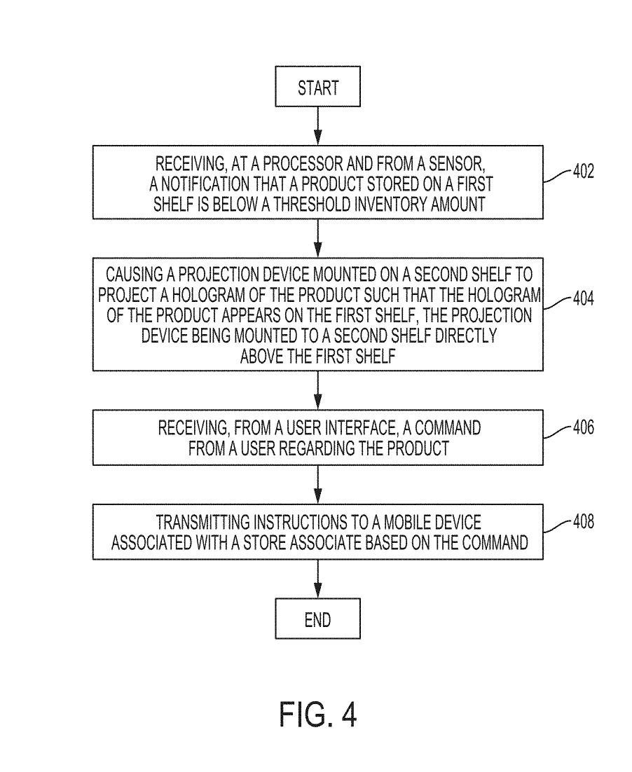

FIG. 4 illustrates an example method embodiment which can be performed using a computing system. The computing system receives, at a processor and from a sensor, a notification that a product stored on a first shelf is below a threshold inventory amount (402). The computer system causes a projection device mounted on a second shelf to project a hologram of the product such that the hologram of the product appears on the first shelf, the projection device being mounted to a second shelf directly above the first shelf (404), and receives, from a user interface, a command from a user regarding the product (406). The hologram can be stored in a database prior to its projection, or more accurately, the database can store a binary code representing the three-dimensional light field which will form the hologram, which the projector will receive from the database and convert into a visible, three-dimensional light field with color and depth—aka a hologram. The system can also verify, for use with the user interface, the store inventory to identify if additional product items are located within the store and if so, the precise location where the additional product is being stored. The computer system then transmits instructions to a mobile device associated with a store associate based on the command (408).

The user interface can be, for example a touch-screen interface, a holographic user interface, or any other type of user interface. In some configurations, the method can be expanded to further include modifying the user interface based on the command received and the instructions transmitted.

While not illustrated, a multi-tiered gondola shelf configured as disclosed herein can include: a first shelf configured to hold a product; a second shelf, which is immediately above the first shelf and separated from the first shelf by a shelf height; a sensor configured to detect when an amount of the product on the first shelf is below a threshold amount; a motion capture device; and a projection device in communication with the sensor, wherein when the sensor detects that the amount of the product on the first shelf is below the threshold amount, the projection device displays: a hologram of the product; and a holographic user interface configured to display information about the product to a user; and wherein as the user interacts with the holographic user interface, the motion capture device: captures movements of the user; translates the movements of the user into a user command; and transmits the user command to the projection device, causing the holographic user interface to be modified based on the user command. Exemplary information which can be displayed on the holographic user interface can include a price of the product, nutritional information or technical information about the product, and a quantity in stock throughout the store. Exemplary movements of the user can include hand motions interacting with the holographic user interface, facial movements of the user, etc.

In such a multi-tiered gondola shelf, the user command can, for example, be a request for additional inventory of the product. The request can then be transmitted to a mobile device associated with a store associate.

In one configuration of the multi-tiered gondola shelf, the motion capture device, the sensor, and the projection device are mounted on an underside of the second shelf.

In some configurations, the multi-tiered gondola shelf can further include a communication system configured to relay information between the sensor, the projection device, and an inventory system, the inventory system having additional inventory information for the product regarding locations other than the first shelf. Similarly, some configurations can include a reflective surface which folds down from the second shelf when the sensor detects the amount of the product is below the threshold amount, where the projection device displays an image onto the reflective surface to form the hologram of the product.

It is noted that features and/or limitations of the various configurations and embodiments discussed herein can be removed, added, or exchanged, so long as such exchange allows for the end product to continue functioning as intended by an end user.

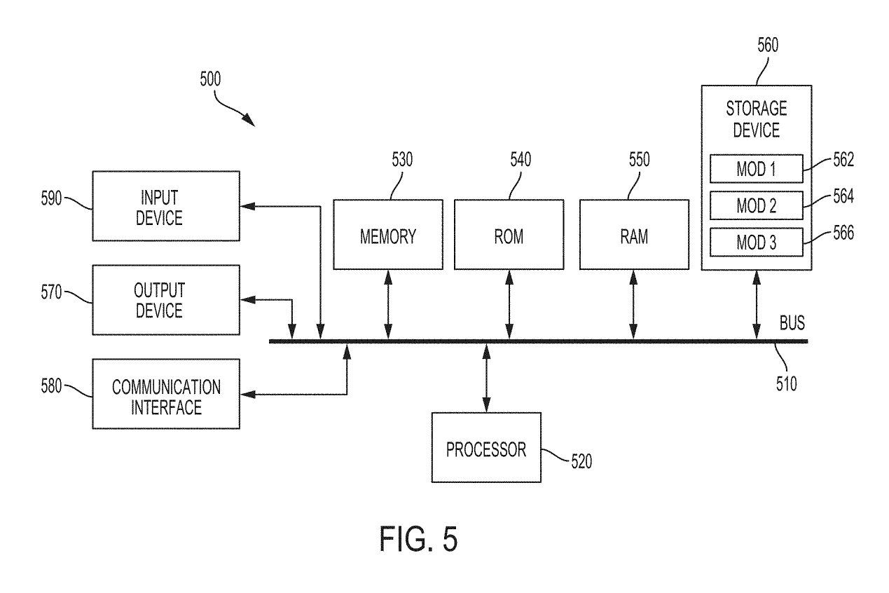

With reference to FIG. 5, an exemplary system 500 includes a general-purpose computing device 500, including a processing unit (CPU or processor) 520 and a system bus 510 that couples various system components including the system memory 530 such as read only memory (ROM) 540 and random access memory (RAM) 550 to the processor 520. The system 500 can include a cache of high speed memory connected directly with, in close proximity to, or integrated as part of the processor 520. The system 500 copies data from the memory 530 and/or the storage device 560 to the cache for quick access by the processor 520. In this way, the cache provides a performance boost that avoids processor 520 delays while waiting for data. These and other modules can control or be configured to control the processor 520 to perform various actions. Other system memory 530 may be available for use as well. The memory 530 can include multiple different types of memory with different performance characteristics. It can be appreciated that the disclosure may operate on a computing device 500 with more than one processor 120 or on a group or cluster of computing devices networked together to provide greater processing capability. The processor 520 can include any general purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in ROM 540 or the like, may provide the basic routine that helps to transfer information between elements within the computing device 500, such as during start-up. The computing device 500 further includes storage devices 560 such as a hard disk drive, a magnetic disk drive, an optical disk drive, tape drive or the like. The storage device 560 can include software modules 562, 564, 566 for controlling the processor 520. Other hardware or software modules are contemplated. The storage device 560 is connected to the system bus 510 by a drive interface. The drives and the associated computer-readable storage media provide nonvolatile storage of computer-readable instructions, data structures, program modules and other data for the computing device 500. In one aspect, a hardware module that performs a particular function includes the software component stored in a tangible computer-readable storage medium in connection with the necessary hardware components, such as the processor 520, bus 510, display 570, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 500 is a small, handheld computing device, a desktop computer, or a computer server.

Although the exemplary embodiment described herein employs the hard disk 560, other types of computer-readable media which can store data that are accessible by a computer, such as magnetic cassettes, flash memory cards, digital versatile disks, cartridges, random access memories (RAMs) 550, and read only memory (ROM) 540, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing device 500. The communications interface 580 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A multi-tiered gondola shelf, comprising:
a first shelf configured to hold a product;
a second shelf, which is immediately above the first shelf and separated from the first shelf by a shelf height;
a sensor configured to detect when an amount of the product on the first shelf is below a threshold amount;
a motion capture device; and
a projection device in communication with the sensor,
wherein when the sensor detects that the amount of the product on the first shelf is below the threshold amount, the projection device displays:
a hologram of the product; and
a holographic user interface configured to display information about the product to a user; and
wherein as the user interacts with the holographic user interface, the motion capture device:
captures movements of the user;
translates the movements of the user into a user command; and
transmits the user command to the projection device, causing the holographic user interface to be modified based on the user command.

2. The multi-tiered gondola shelf of claim 1, wherein the user command is a request for additional inventory of the product.

3. The multi-tiered gondola shelf of claim 2, wherein the request is transmitted to a mobile device associated with a store associate.

4. The multi-tiered gondola shelf of claim 1, wherein the motion capture device, the sensor, and the projection device are mounted on an underside of the second shelf.

5. The multi-tiered gondola shelf of claim 1, wherein the information about the product which is displayed by the holographic user interface comprises at least one of a price, nutritional information, and a quantity in stock.

6. The multi-tiered gondola shelf of claim 1, further comprising:
a communication system configured to relay information between the sensor, the projection device, and an inventory system, the inventory system having additional inventory information for the product regarding locations other than the first shelf.

7. The multi-tiered gondola shelf of claim 1, further comprising:
a reflective surface which folds down from the second shelf when the sensor detects the amount of the product is below the threshold amount, wherein the projection device displays an image onto the reflective surface to form the hologram of the product.

8. The multi-tiered gondola shelf of claim 1, wherein the movements of the user comprise hand motions interacting with the holographic user interface.

9. A shelving system, comprising:
a first shelf configured to hold a product;
a second shelf, which is immediately above the first shelf and separated from the first shelf by a shelf height;
a sensor configured to detect when an amount of the product on the first shelf is below a threshold amount; and
a projection device in communication with the sensor,
wherein when the sensor detects that the amount of the product on the first shelf is below the threshold amount, the projection device displays a holographic user interface configured to display information about the product to a user.

10. The shelving system of claim 9, further comprising a motion capture device configured to capture movements of the user as the user interacts with the holographic user interface.

11. The shelving system of claim 10, wherein the movements of the user initiate a request for additional inventory of the product.

12. The shelving system of claim 11, wherein the request is transmitted to a mobile device associated with a store associate.

13. The shelving system of claim 9, wherein the sensor and the projection device are mounted on an underside of the second shelf.

14. The shelving system of claim 9, wherein the information about the product which is displayed by the holographic user interface comprises at least one of a price, nutritional information, and a quantity in stock.

15. The shelving system of claim 9, further comprising:
a communication system configured to relay information between the sensor, the projection device, and an inventory system, the inventory system having additional inventory information for the product regarding locations other than the first shelf.

16. The shelving system of claim 9, wherein the holographic user interface is projected in a space between the first shelf and the second shelf, the holographic user interface having a height less than the shelf height.

17. A method comprising:
receiving, at a processor and from a sensor, a notification that a product stored on a first shelf is below a threshold inventory amount;
causing a projection device mounted on a second shelf to project a hologram of the product such that the hologram of the product appears on the first shelf, the projection device being mounted to a second shelf directly above the first shelf;
receiving, from a user interface, a command from a user regarding the product; and
transmitting instructions to a mobile device associated with a store associate based on the command.

18. The method of claim 17, wherein the user interface is a touch-screen interface.

19. The method of claim 17, wherein the user interface is a holographic user interface.

20. The method of claim 17, further comprising:
modifying the user interface based on the command received and the instructions transmitted.
